(19) United States
(12) Patent Application Publication
(10) Pub. No.: US 2021/0089486 A1
(43) Pub. Date: Mar. 25, 2021

(54) INFORMATION PROCESSING SYSTEM AND INFORMATION PROCESSING METHOD

(71) Applicant: Fujitsu Client Computing Limited, Kawasaki-shi (JP)

(72) Inventor: Tsuyoshi KAJIYA, Kawasaki (JP)

(21) Appl. No.: 16/936,637

(22) Filed: Jul. 23, 2020

(30) Foreign Application Priority Data
Sep. 19, 2019 (JP) 2019-169951

(51) Int. Cl. G06F 13/40; G06F 9/38

(52) U.S. Cl. CPC G06F 13/4022; G06F 9/38; G06F 13/4045

(57) ABSTRACT

An information processing system includes a relay apparatus that includes a relay unit for relaying communication over an expansion bus, a plurality of computing apparatuses each connected to the expansion bus, and an information processing apparatus connected to the expansion bus. The information processing apparatus controls computational processing performed by the plurality of computing apparatuses via the expansion bus and relay unit while running a first operating system (OS). In addition, the information processing apparatus switches the running OS to a second OS, and recovers one computing apparatus among the plurality of computing apparatuses by rewriting the system data of the one computing apparatus.

### CROSS-REFERENCE TO RELATED APPLICATION

This application is based upon and claims the benefit of priority of the prior Japanese Patent Application No. 2019-169951, filed on Sep. 19, 2019, the entire contents of which are incorporated herein by reference.

### FIELD

The embodiments discussed herein relate to an information processing system and an information processing method.

### BACKGROUND

In recent years, personal computers (PCs) have been used as a base for performing high load processing such as artificial intelligence (AI) inference and image processing. For example, there has been proposed an information processing system in which an information processing apparatus having a configuration similar to that of a general PC and a plurality of computing apparatuses that perform AI processing are connected to each other via a relay apparatus. In this information processing system, the computing apparatuses collaborate with each other under the control of the information processing apparatus to perform AI processing and image processing in a distributed manner. In addition, the relay apparatus performs communication with each of the information processing apparatus and computing apparatuses using a peripheral component interconnect express (PCI express, or PCIe, registered trademark) expansion bus, which enables high speed communication.

See, for example, Japanese Patent No. 6536735.

By the way, there are cases where a computing apparatus needs to be recovered by rewriting the system data of the computing apparatus due to a failure or the like occurring in the computing apparatus. In this connection, how to recover a computing apparatus depends on the type and manufacturer of the computing apparatus. For example, some computing apparatuses need to be recovered only under control from an apparatus running a specific operating system (OS).

In a system where computing apparatuses operate under the control of an information processing apparatus, it is preferable to recover computing apparatuses under control from the information processing apparatus, for a simple recovery procedure and an efficient recovery operation. However, the information processing apparatus may run an OS different from the one that is able to recover the computing apparatus. In this case, it is not possible to recover the computing apparatus under control from the information processing apparatus.

### SUMMARY

According to one aspect, there is provided an information processing system including: a relay apparatus including a relay unit configured to relay communication over an expansion bus; a plurality of computing apparatuses each connected to the expansion bus; and an information processing apparatus configured to control computational processing performed by the plurality of computing apparatuses via the expansion bus and the relay unit while running a first operating system, to switch a running operating system to a second operating system, and to rewrite system data of one computing apparatus among the plurality of computing apparatuses in order to recover the one computing apparatus.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a configuration and processing of an information processing system according to a first embodiment;

FIG. 2 illustrates an example of a configuration of an information processing system according to a second embodiment;

FIG. 3 illustrates an example where an information processing system is applied to edge computing;

FIG. 4 illustrates an example of a hardware configuration of each apparatus in an information processing system;

FIG. 5 is a view illustrating the connectivity of signal lines between apparatuses in an information processing system;

FIG. 6 illustrates an example of a configuration of PCIe connectors that connect apparatuses;

FIG. 7 illustrates an example of a configuration of processing functions in an information processing system;

FIG. 8 illustrates an outline of a recovery procedure for a computing apparatus (part 1);

FIG. 9 illustrates an outline of a recovery procedure for a computing apparatus (part 2);

FIG. 10 is a sequence diagram illustrating an example of a recovery procedure for a computing apparatus;

FIG. 11 illustrates an example of a configuration of processing functions according to a modification example of the second embodiment;

FIG. 12 illustrates an example of a configuration of processing functions in an information processing system according to a third embodiment;

FIG. 13 illustrates an outline of a recovery procedure for a computing apparatus according to the third embodiment (part 1);

FIG. 14 illustrate an outline of a recovery procedure for a computing apparatus according to the third embodiment (part 2); and

FIG. 15 is a sequence diagram illustrating an example of a recovery procedure for a computing apparatus according to the third embodiment.

### DESCRIPTION OF EMBODIMENTS

Hereinafter, preferred embodiments will be described with reference to the accompanying drawings.

### First Embodiment

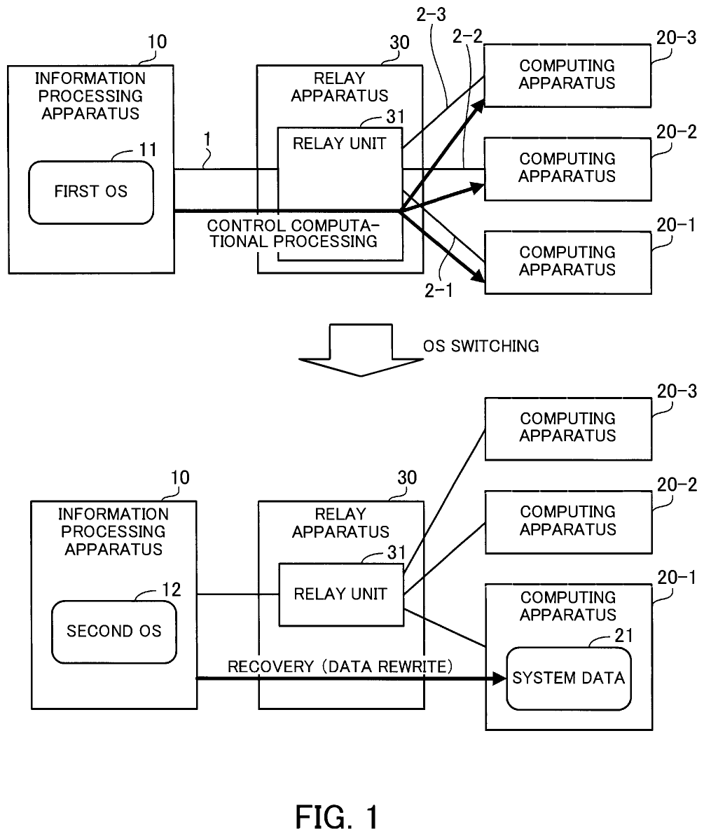

FIG. 1 illustrates an example of a configuration and processing of an information processing system according to a first embodiment. The information processing system illustrated in FIG. 1 includes an information processing apparatus 10, computing apparatuses 20-1 to 20-3, and a relay apparatus 30. The number of computing apparatuses is not limited to a particular number but may be two, or four or more.

The information processing apparatus 10 is connected to the relay apparatus 30 with an expansion bus 1. The computing apparatuses 20-1 to 20-3 are connected to the relay apparatus 30 respectively with expansion buses 2-1 to 2-3. The relay apparatus 30 includes a relay unit for relaying communication over the expansion buses 1 and 2-1 to 2-3. For example, the expansion buses 1 and 2-1 to 2-3 are PCIe buses.

As seen in the upper part of FIG. 1, the information processing apparatus 10 controls computational processing performed by the computing apparatuses 20-1 to 20-3 through communication via the relay unit 31. The computing apparatuses 20-1 to 20-3 perform the computational processing under the control of the information processing apparatus 10. For example, the computing apparatuses 20-1 to 20-3 perform AI inference and image processing under the control of the information processing apparatus 10. The information processing apparatus 10 controls the computational processing of the computing apparatuses 20-1 to 20-3 while running a first OS 11.

The computing apparatuses 20-1 to 20-3 are able to be recovered by rewriting locally stored system data with new system data. For example, when the computing apparatus 20-1 fails, the system data of the computing apparatus 20-1 is rewritten to recover the computing apparatus 20-1. As a result, the computing apparatus 20-1 is able to return back to normal operation.

Note that, in this embodiment, only an apparatus running a second OS 12 different from the above first OS 11 is able to recover the computing apparatuses 20-1 to 20-3. Therefore, the computing apparatuses 20-1 to 20-3 are unable to be recovered under control from the information processing apparatus 10 running the first OS 11.

To deal with this, as seen in the lower part of FIG. 1, the information processing apparatus 10 switches the running OS from the first OS 11 to the second OS 12. Then, while running the second OS 12, the information processing apparatus 10 rewrites the system data 21 of a computing apparatus (computing apparatus 20-1 in FIG. 1) to be recovered among the computing apparatuses 20-1 to 20-3, to thereby recover the computing apparatus.

The above approach makes it possible to recover the computing apparatuses under control from the information processing apparatus 10. That is, the information processing apparatus 10 that controls the computational processing of the computing apparatuses 20-1 to 20-3 is able to recover the computing apparatuses 20-1 to 20-3. This simplifies the recovery procedure and streamlines the recovery operation.

In this connection, for example, in the case of rewriting the system data 21 of a computing apparatus under control from the information processing apparatus 10, instruction information for the rewriting and update data corresponding to the system data 21 are transferred from the information processing apparatus 10 to the computing apparatus. Such information and data are transferred through a signal line passing from the information processing apparatus 10 via the relay apparatus 30 to the computing apparatus. In this case, the expansion buses 1 and 2-1 to 2-3 may be used as the signal line. Alternatively, such information and data may be transferred through a signal line passing from the information processing apparatus 10 to the computing apparatus, not via the relay apparatus 30.

### Second Embodiment

The following describes an information processing system using PCIe buses as expansion buses.

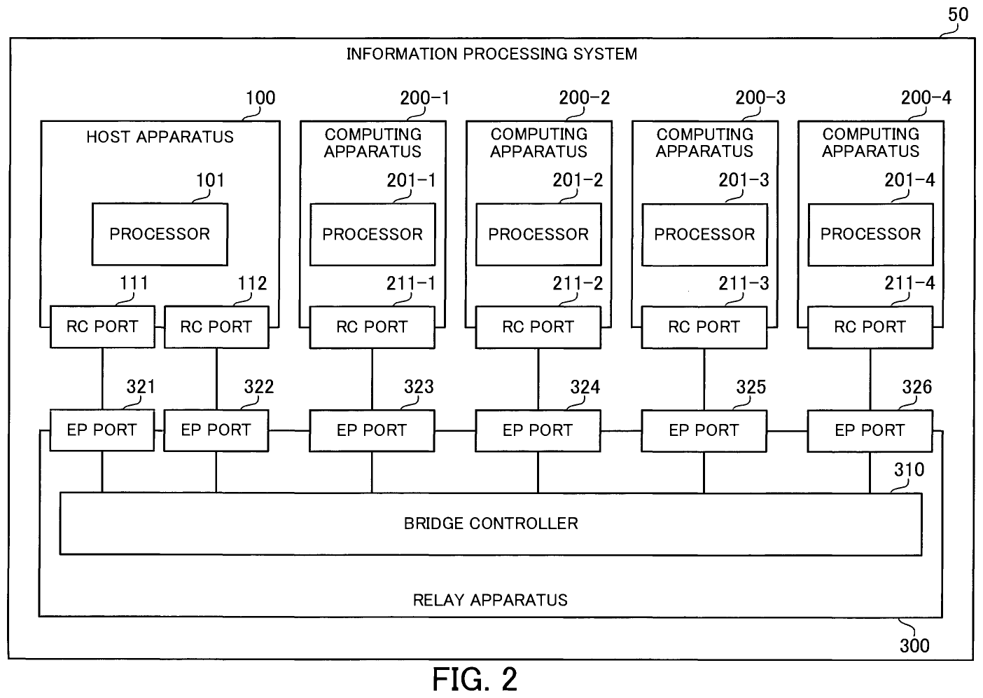

FIG. 2 illustrates an example of a configuration of an information processing system according to a second embodiment. The information processing system 50 illustrated in FIG. 2 includes a host apparatus 100, computing apparatuses 200-1 to 200-4, and a relay apparatus 300. The host apparatus 100 and computing apparatuses 200-1 to 200-4 are connected to the relay apparatus 300. In addition, the host apparatus 100, computing apparatuses 200-1 to 200-4, and relay apparatus 300 are accommodated in one housing. Although FIG. 2 illustrates the information processing system 50 with the four computing apparatuses 200-1 to 200-4 by way of example, the number of computing apparatuses is not limited to this number.

The host apparatus 100 is an information processing apparatus with a processor 101 and is configured to control the information processing system 50 as a whole and to provide a graphical user interface (GUI). The host apparatus 100 is an information processing apparatus that has a PC-based architecture. For example, an Intel x-86 compatible processor is installed as the processor 101 and Windows (registered trademark) is used as an OS.

The computing apparatuses 200-1 to 200-4 are information processing apparatuses that have processors 201-1 to 201-4, respectively. The computing apparatuses 200-1 to 200-4 collaborate with each other to perform AI inference and image processing under the control of the host apparatus 100. As each processor 201-1 to 201-4, a processor suitable for carrying out specific processing, such as a graphics processing unit (GPU) or a field programmable gate array (FPGA), is installed. In addition, Linux (registered trademark) is used as an OS. In this connection, the processors 201-1 to 201-4 may be from the same manufacturer (vendor) or different manufacturers.

The relay apparatus 300 includes a bridge controller 310 functioning as a PCIe bridge. The host apparatus 100 and computing apparatuses 200-1 to 200-4 perform PCIe-based communication with the bridge controller 310, and the bridge controller 310 relays communication between the host apparatus 100 and each computing apparatus 200-1 to 200-4.

In the PCIe communication, each of the processors 101 and 201-1 to 201-4 acts as a root complex (RC) residing on the host side, whereas the bridge controller 310 acts as an end point (EP) residing on the device side. Then, data transfer is performed between each host and the device.

The host apparatus 100 has RC ports 111 and 112 as RC-side physical communication ports (connectors). The computing apparatuses 200-1 to 200-4 have RC ports 211-1 to 211-4 as RC-side physical communication ports, respectively. The relay apparatus 300 has EP ports 321 to 326 as EP-side physical communication ports. The RC ports 111 and 112 are connected to the EP ports 321 and 322, respectively, and the RC ports 211-1 to 211-4 are connected to the EP ports 323 to 326, respectively. In addition, the bridge controller 310 has an interconnect bus (not illustrated). The EP ports 321 to 326 are connected to this interconnect bus so that data is transferred between the EP ports 321 to 326 through the interconnect bus.

As described above, in the information processing system 50, the processors 101 and 201-1 to 201-4 of the host apparatus 100 and computing apparatuses 200-1 to 200-4 each act as RC. In addition, the EP ports 321 to 326 respectively connected to the host apparatus 100 and computing apparatuses 200-1 to 200-4 each act as EP. The bridge controller 310 uses PCIe for fast data transfer between the host apparatus 100 and each computing apparatus 200-1 to 200-4 and performs data transfer between the EPs on the device side.

In addition, the bridge controller 310 tunnels data from one end point to another end point (EP to EP) in the data transfer between the plurality of RCs. That is, the data transfer from one RC to another RC involves data tunneling between EPs. RCs are logically connected for communication when a PCIe transaction occurs. Parallel data transfer is possible between a plurality of different combinations of RCs if the data transfer is not from a plurality of RCs only to one RC.

The computing apparatuses 200-1 to 200-4 perform AI inference and image processing in a distributed manner, and the host apparatus 100 controls this distributed processing. For example, the host apparatus 100 instructs the computing apparatuses 200-1 to 200-4 to perform the AI inference or image processing and receives the processing results from the computing apparatuses 200-1 to 200-4. Communication for such distributed processing is performed by communication between the RCs via the bridge controller 310.

In addition, in the above configuration, even when processors (processors 101 and 201-1 to 201-4) acting as RCs perform communication with each other, the OS running on each processor sees only the bridge controller 310 and does not see any other processor. Therefore, each processor does not need to manage the communication partner's processor directly, and the processors may just be managed by the device driver of the bridge controller 310 to which the processors are connected. For this reason, in the information processing system 50, there is no need of installing device drivers individually dedicated for controlling each communication partner's processor in each processor. In order to achieve communication between the processors, the device driver of the bridge controller 310 just needs to process the communication. Because of this feature, there are no restrictions on the type of OS on each processor, meaning that different OSs may run on the processors.

In addition, to strengthen security, each RC-side processor is able to set up a virtual local area network (LAN) to communicate with another RC-side processor. In this case, data is encapsulated, tunneled, and transferred to the destination processor. Each RC-side apparatus uses only a device driver for performing PCIe-based communication with the bridge controller 310 and a virtual LAN driver for setting up a virtual LAN in order to perform communication over the virtual LAN, irrespective of the types of the processor and OS of the communication partner.

In the following description, the computing apparatuses 200-1 to 200-4 may collectively be referred to as “computing apparatus 200,” unless distinctly stated otherwise. In addition, the processors 201-1 to 201-4 may collectively be referred to as “processor 201,” unless distinctly stated otherwise. Likewise, the RC ports 211-1 to 211-4 may collectively be referred to as “RC port 211,” unless distinctly stated otherwise.

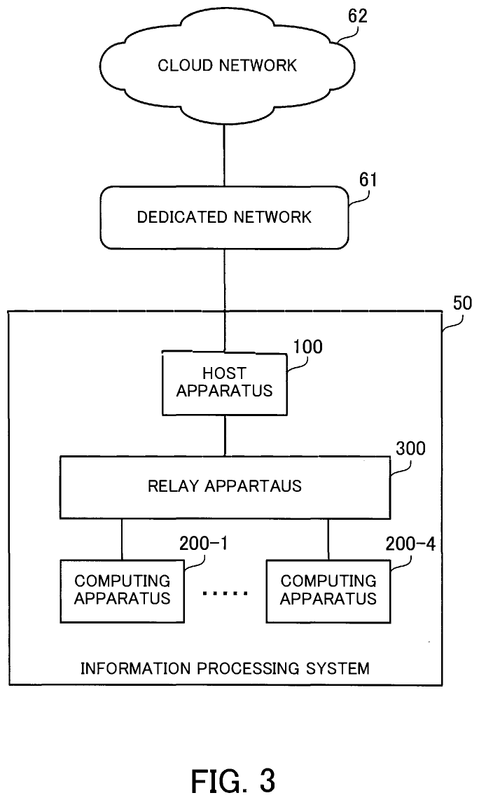

FIG. 3 illustrates an example where an information processing system is applied to edge computing. Taking the host apparatus 100 of FIG. 2 as an edge server, the information processing system 50 is applicable to edge computing.

The edge computing system illustrated in FIG. 3 includes the information processing system 50, a dedicated network 61, and a cloud network 62. The host apparatus 100 in the information processing system 50 is connected to the dedicated network 61, and the dedicated network 61 is connected to the cloud network 62. The host apparatus 100 aggregates data processed by the computing apparatuses 200-1 to 200-4 having the function of EP and sends the resultant to the cloud network 62 over the dedicated network 61.

The above configuration makes it possible to perform processing at the edge side while saving resources at the cloud side. This leads to reducing the response time over the cloud network 62 and thus ensuring the real-time performance. Further, data is processed by the host apparatus 100 (edge) and the processing result is sent to the cloud network 62, which leads to ensuring the data confidentiality. Still further, data is processed by the host apparatus 100 and only needed data is sent to the cloud network 62, which leads to reducing the communication volume.

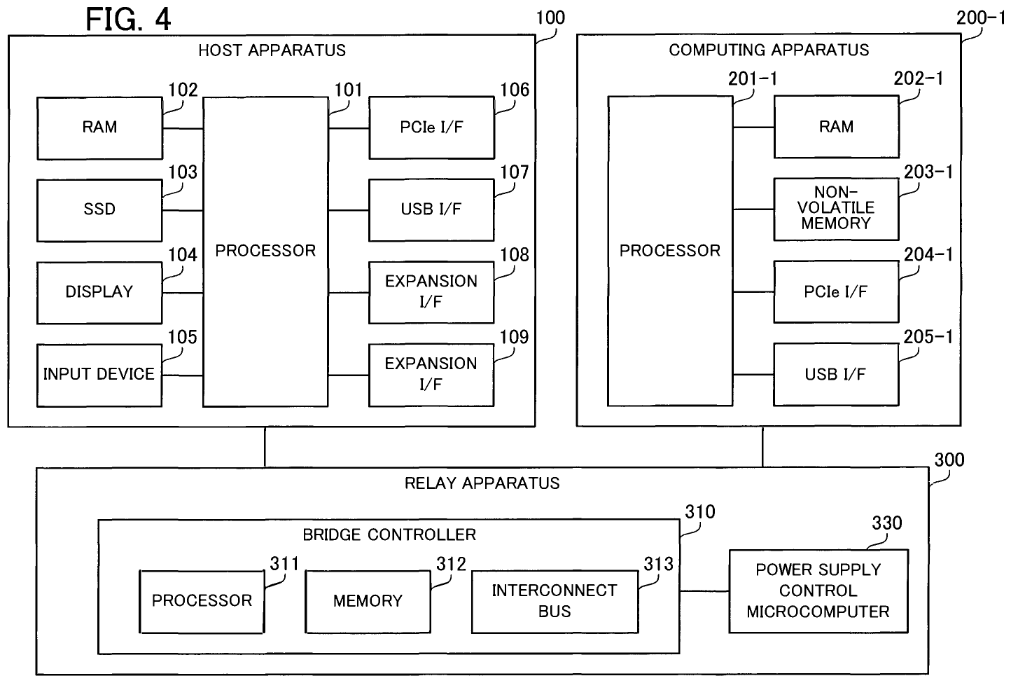

FIG. 4 illustrates an example of a hardware configuration of each apparatus in an information processing system.

The host apparatus 100 includes a processor 101, a random access memory (RAM) 102, a solid state drive (SSD) 103, a display 104, an input device 105, a PCIe interface (I/F) 106, a universal serial bus (USB) interface (I/F) 107, and expansion interfaces (I/F) 108 and 109.

The processor 101 controls the host apparatus 100 as a whole. The processor 101 is a central processing unit (CPU), a micro processing unit (MPU), a digital signal processor (DSP), an application specific integrated circuit (ASIC), or a programmable logic device (PLD), for example. Alternatively, the processor 101 may be a combination of two or more devices selected from CPU, MPU, DSP, ASIC, and PLD.

The RAM 102 is used as a primary memory device of the host apparatus 100. The RAM 102 temporarily stores therein at least part of OS and application programs to be executed by the processor 101. The RAM 102 also stores therein a variety of data to be used by the processor 101 in processing.

The SSD 103 is used as a secondary storage device of the host apparatus 100. The SSD 103 stores therein OS and application programs and a variety of data. Another type of non-volatile storage device such as a hard disk drive (HDD) may be used as the secondary storage device.

The display 104 displays images in accordance with instructions from the processor 101. The display 104 is a liquid crystal display or an organic electroluminescence (EL) display, for example.

The input device 105 receives user inputs and outputs a signal based on the inputs to the processor 101. The input device 105 is a keyboard or a pointing device, for example. Examples of the pointing device include a mouse, a touch panel, a tablet, a touchpad, a track ball, and others.

In this connection, at least one of the display 104 and input device 105 may externally be connected to the host apparatus 100.

The PCIe interface 106 is an interface device that performs PCIe-based communication via the RC ports 111 and 112.

The USB interface 107 is an interface device that performs communication with a USB device. For example, as the USB device, a USB memory may be connected. In addition, as the USB device, a reading device for portable storage media may be connected. The portable storage media include optical discs, magneto-optical disks, semiconductor memories, and others.

The expansion interfaces 108 and 109 are interface devices that enable communication via expansion ports to be described later. The expansion interface 108 enables communication via a general-purpose input/output (GPIO) built on a chipset of the host apparatus 100. The expansion interface 109 enables communication over an I²C (registered trademark) bus.

The following describes an example of a hardware configuration of the computing apparatus 200 (computing apparatuses 200-1 to 200-4). The computing apparatus 200 includes a processor 201, a RAM 202, a non-volatile memory 203, a PCIe interface (I/F) 204, and a USB interface (I/F) 205.

The processor 201 is a processor suitable for parallel computational processing for AI inference and image processing. For example, the processor 201 may be implemented by an accelerator, such as a GPU, an FPGA, or a dedicated chip. Alternatively, the processor 201 may be a combination of CPU and GPU, for example. The processor 201 operates as a co-processor that collaborates with other processors 201 under the control of the processor 101 of the host apparatus 100.

The RAM 202 temporarily stores therein at least part of programs to be executed by the processor 201 and a variety of data to be used during the execution of the programs.

The non-volatile memory 203 stores therein programs to be executed by the processor 201 and a variety of data to be used during the execution of the programs. The non-volatile memory 203 is implemented by a flash memory, for example.

The PCIe interface 204 is an interface device that performs PCIe-based communication via the RC port 211.

The USB interface 205 is an interface device that performs communication with a USB device. The USB interface 205 is used for rewriting the system data stored in the non-volatile memory 203 to recover the computing apparatus 200, as will be described later.

The relay apparatus 300 includes a bridge controller 310 and a power supply control microcomputer 330.

The bridge controller 310 includes a processor 311, a memory 312, and an interconnect bus 313. The interconnect bus 313 transfers data between the EP ports 321 to 326 (see FIG. 2). The processor 311 changes connections between the EP ports 321 to 326 in the interconnect bus 313 and controls communication between the EP ports 321 to 326. The memory 312 stores therein programs to be executed by the processor 311 and a variety of data to be used during the execution of the programs.

The power supply control microcomputer 330 controls power supply within the information processing system 50 as a whole. For example, the power supply control microcomputer 330 is able to control the power on and off of the computing apparatuses 200-1 to 200-4 individually in accordance with instructions from the host apparatus 100.

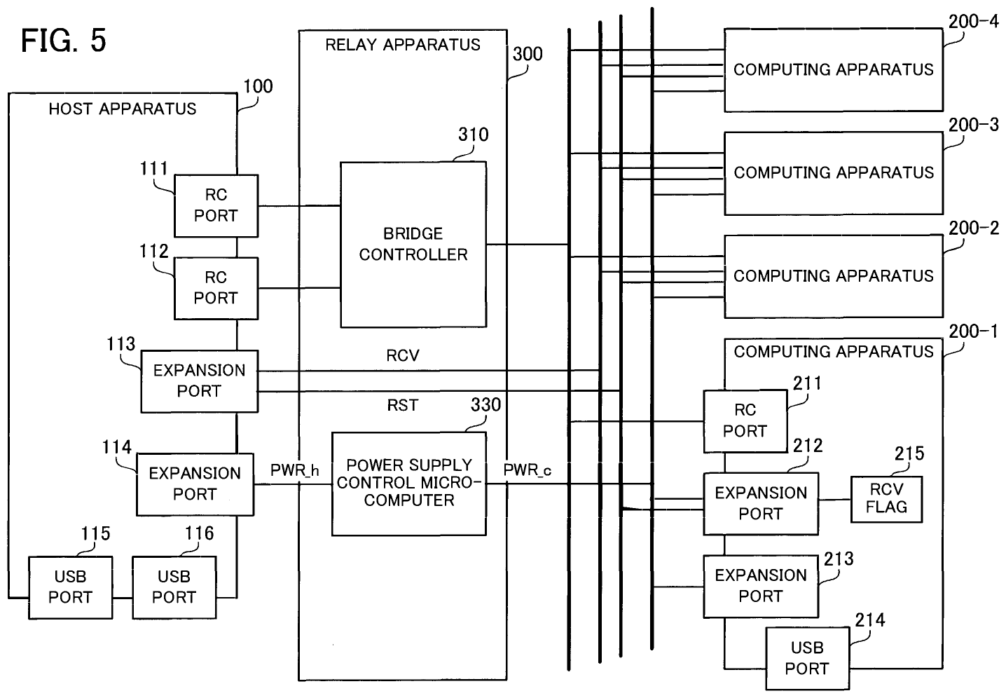

The following describes the connectivity of main signal lines between the apparatuses in the information processing system 50, with reference to FIG. 5. FIG. 5 is a view illustrating the connectivity of signal lines between apparatuses in an information processing system.

The host apparatus 100 has RC ports 111 and 112, expansion ports 113 and 114, and USB ports 115 and 116 as physical communication ports. The computing apparatus 200-1 has an RC port 211 (actually, RC port 211-1), expansion ports 212 and 213, and a USB port 214 as physical communication ports. Although not illustrated, the computing apparatuses 200-2 to 200-4 each have physical communication ports that are identical to the RC port 211, expansion ports 212 and 213, and USB port 214.

As described earlier, the RC ports 111 and 112 of the host apparatus 100 are connected to the bridge controller 310 of the relay apparatus 300 via the EP ports 321 and 322 of the relay apparatus 300, respectively. In addition, the RC port 211 of the computing apparatus 200-1 is connected to the bridge controller 310 of the relay apparatus 300 via the EP port 323 of the relay apparatus 300. PCIe-based communication is performed between each RC port 111 and 112 and the RC port 211 via the bridge controller 310. In addition, a virtual LAN may be set up to perform communication between each RC port 111 and 112 and the RC port 211.

The expansion port 113 of the host apparatus 100 is a physical communication port of the expansion interface 108 and is used for communication via the GPIO built on the chipset of the host apparatus 100. The expansion port 113 has, connected thereto, a recovery signal line RCV and a reset signal line RST. The recovery signal line RCV and reset signal line RST are connected to the expansion port 212 of the computing apparatus 200-1 via the relay apparatus 300. The computing apparatus 200-1 holds flag information called an RCV flag 215 that may be set using the recovery signal line RCV via the expansion port 212. In addition, the reset signal line RST is used to carry an instruction signal for rebooting the computing apparatus 200.

Such an expansion port 212 and RCV flag 215 are provided in the computing apparatuses 200-2 to 200-4 as well as in the computing apparatus 200-1. The recovery signal line RCV and reset signal line RST are connected to each expansion port 212 of the computing apparatuses 200-1 to 200-4 via the relay apparatus 300. Using the recovery signal line RCV, the RCV flag 215 of each computing apparatus 200-1 to 200-4 is set via the corresponding expansion port 212. In addition, using the reset signal line RST, an instruction is made to reboot a specified one of the computing apparatuses 200-1 to 200-4 via the corresponding expansion port 212.

The recovery signal line RCV, reset signal line RST, and RCV flag 215 will be described in detail later.

The expansion port 114 of the host apparatus 100 is a physical communication port of the expansion interface 109, and is connected to the power supply control microcomputer 330 with a power supply control signal line PWR_h. The power supply control signal line PWR_h is implemented by an I²C bus, for example. The host apparatus 100 outputs a power supply control signal from the expansion port 114 in order to instruct the power supply control microcomputer 330 to power on and off a specified one of the computing apparatuses 200-1 to 200-4.

The expansion port 213 of the computing apparatus 200-1 is connected to the power supply control microcomputer 330 with a power supply control signal line PWR_c. The power supply control signal line PWR_c is also implemented by an I²C bus, for example. When receiving a power supply control signal sent from the power supply control microcomputer 330 via the expansion port 213, the computing apparatus 200-1 changes from power-off to power-on or from power-on to power-off. The power supply control signal from the power supply control microcomputer 330 may also be sent to each expansion port 213 of the computing apparatuses 200-2 to 200-4. By doing so, the power supply state of each computing apparatus 200-2 to 200-4 is controlled using the power supply control signal.

In this connection, the reset signal line RST is a signal line for rebooting a computing apparatus to be recovered. Alternatively, the power supply control signal from the expansion port 114 may be used to make an instruction to reboot the computing apparatus. In the case of making an instruction to reboot the computing apparatus using the power supply control signal that is output from the expansion port 114, the reset signal line RST is not needed.

By the way, the recovery of the computing apparatus 200 is desired when the computing apparatus 200 malfunctions. For example, there is a recovery method of rewriting the image (system image) of system data of the computing apparatus 200.

Note that various types and manufacturers of processors and modules on which the processors are mounted may be used for the processor 201 of the computing apparatus 200 and the module on which the processor 201 is mounted. The recovery method depends on the manufacturer and type of the processor 201 and module. In this embodiment, a module is assumed for which the following procedures are defined for recovery, by way of example.

(Procedure 1) Operate a switch provided on a module to set the module to recovery mode.

(Procedure 2) Connect a maintenance computer on which a specific maintenance OS (for example, Linux-based OS) runs to a USB terminal of the module in recovery mode and transfer a system image from the maintenance computer to rewrite the system image in the module.

First, the procedure 1 will be considered. To carry out the procedure 1 in the information processing system 50, there needs a design such that a maintenance operator is able to operate the switch for setting to recovery mode. For example, an opening is formed in the vicinity of each computing apparatus in the housing of the information processing system 50 so that the switch is operable through the opening. However, as described above, various manufacturers and types of processors 201 and modules may be mounted in the computing apparatuses 200. Therefore, it is not realistic to implement such a design, like the above opening, dedicated for a specific manufacturer and type of processor and module. In addition, it is troublesome and inefficient to remove the housing of the information processing system 50 and operate the above switch each time a computing apparatus is recovered.

The recovery operation with as little labor as possible is preferable. In view of this, even operating the switch of a module by the operator is considered troublesome and inefficient. In the information processing system 50, each computing apparatus 200 operates under the control of the host apparatus 100. Therefore, to enhance the efficiency of the recovery operation, it is desirable that the recovery operation is performed under as much control as possible from the host apparatus 100.

To this end, in this embodiment, a recovery signal line RCV and a reset signal line RST are added as signal lines for use by the host apparatus 100 to set the computing apparatus 200 to recovery mode, as illustrated in FIG. 5. The recovery signal line RCV is a signal line for setting the RCV flag 215 in the computing apparatus 200. The RCV flag 215 is set to “1” when the signal level on the recovery signal line RCV is high, and is set to “0” when the signal level is low. The reset signal line RST is a signal line for rebooting the computing apparatus 200 (for powering off and then on). By setting the reset signal line RST from low level to high level for a prescribed period of time, an instruction to reboot the computing apparatus 200 is made.

The RCV flag 215 is referenced by the processor 201 when the computing apparatus 200 starts up. When the RCV flag 215 is “0” at the startup of the computing apparatus 200, the processor 201 performs the startup process in normal mode, so that the computing apparatus 200 starts up in normal mode. When the RCV flag 215 is “1” at the startup of the computing apparatus 200, the processor 201 performs the startup process in recovery mode, so that the computing apparatus 200 starts up in recovery mode.

With the above configuration, it becomes possible to switch the computing apparatuses 200-1 to 200-4 to recovery mode under the control of the host apparatus 100 led by the maintenance operator giving inputs to the host apparatus 100. More specifically, the host apparatus 100 exercises control so as to set the recovery signal line RCV to high level and then to set the reset signal line RST to high level to reboot a computing apparatus 200 to be recovered. Thereby, the computing apparatus 200 starts up in recovery mode. This enhances the efficiency of the operation of setting the computing apparatus 200 to recovery mode.

In this connection, the host apparatus 100 is able to make an instruction to reboot the computing apparatus 200 to be recovered, using a power supply control signal that is output from the expansion port 114 to the power supply control microcomputer 330 through the power supply control signal line PWR_h. This case eliminates the need of providing the reset signal line RST. Alternatively, the following method may be used to make an instruction to reboot the computing apparatus 200. The relay apparatus 300 is provided with another expansion port (for example, RS232C port, RS standing for recommended standard) for use by the power supply control microcomputer 330 to perform communication. The USB port 115 (or USB port 116) of the host apparatus 100 and this expansion port are connected to each other with a universal asynchronous receiver/transmitter (UART) cable, and an instruction signal for rebooting a specified computing apparatus 200 is sent through this cable.

The above procedure 2 will now be considered. In this embodiment, the transfer of a system image to the computing apparatus 200 is performed by operating the host apparatus 100, not by connecting a maintenance computer to a USB terminal of the computing apparatus 200. This streamlines the recovery operation.

In this connection, as described earlier, in the information processing system 50, there are no restrictions on the types of OSs that run on the host apparatus 100 and the computing apparatuses 200-1 to 200-4. Therefore, a maintenance OS used to transfer the system image may be different from an OS (main OS) that normally runs on the host apparatus 100.

To deal with this, in this embodiment, at the time of recovering the computing apparatus 200, the OS running on the host apparatus 100 is switched from the main OS to the maintenance OS. For example, the host apparatus 100 sets the recovery signal line RCV to high level and makes an instruction to reboot the computing apparatus 200 to be recovered, on an application running on the main OS. After that, the host apparatus 100 switches the OS to the maintenance OS, and transfers the system image to the computing apparatus 200 on an application (installer) running on the maintenance OS. In this way, even in the case where the main OS that normally runs on the host apparatus 100 is different from the maintenance OS, it is possible to transfer the system image to the computing apparatus 200 and rewrite the system data of the computing apparatus 200 under control from the host apparatus 100. This streamlines the recovery operation.

The above series of processing enables recovering the computing apparatus 200 under control from the host apparatus 100, without the need of a mechanism dedicated for a specific processor 201 and module in the housing of the information processing system 50. As a result, the efficiency of the recovery operation is enhanced. In addition, the maintainability of the computing apparatus 200 is enhanced.

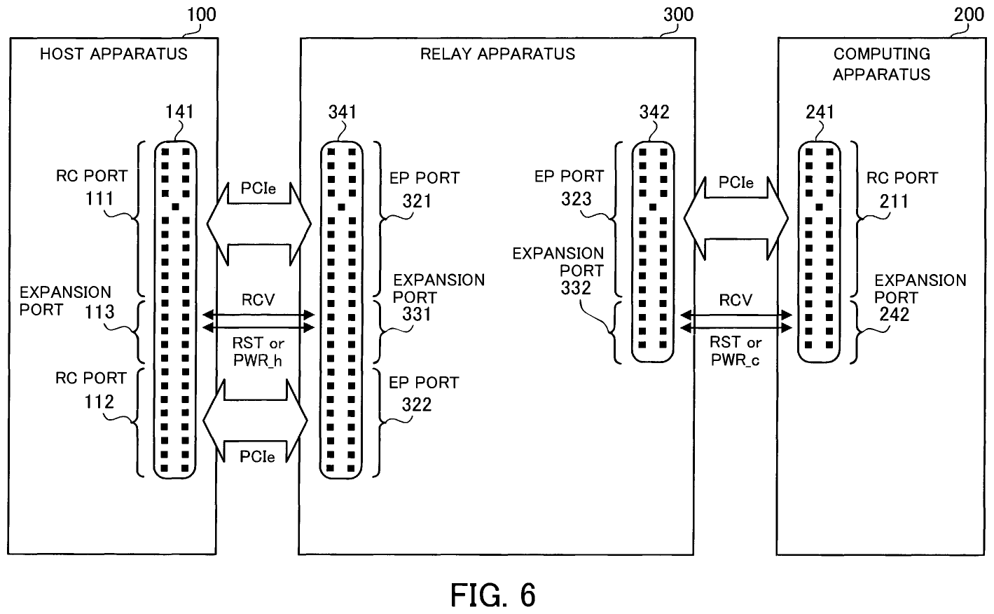

FIG. 6 illustrates an example of a configuration of PCIe connectors that connect apparatuses.

The host apparatus 100 has a PCIe connector 141. The relay apparatus 300 has a PCIe connector 341. The PCIe connector 141 and the PCIe connector 341 are connected to each other. For example, the PCIe connector 141 and the PCIe connector 341 are connected to each other, directly or with a PCIe cable.

A partial region of the PCIe connector 141 is used as the RC port 111, another partial region of the PCIe connector 141 is used as the RC port 112, and the remaining partial region of the PCIe connector 141 is used as the expansion port 113. In addition, a partial region of the PCIe connector 341 is used as the EP port 321, another partial region of the PCIe connector 341 is used as the EP port 322, and the remaining partial region of the PCIe connector 341 is used as an expansion port 331.

When the PCIe connector 141 and the PCIe connector 341 are connected to each other, PCIe-based communication is performed using signal lines included in the region of the PCIe connector 141 corresponding to the RC port 111 and the region of the PCIe connector 341 corresponding to the EP port 321. Further, PCIe-based communication is performed using signal lines included in the region of the PCIe connector 141 corresponding to the RC port 112 and the region of the PCIe connector 341 corresponding to the EP port 322. Still further, signal lines included in the region of the PCIe connector 141 corresponding to the expansion port 113 and the region of the PCIe connector 341 corresponding to the expansion port 331 are used as the recovery signal line RCV and the reset signal line RST.

In addition, the relay apparatus 300 has a PCIe connector 342. The computing apparatus 200 has a PCIe connector 241. The PCIe connector 342 and the PCIe connector 241 are connected to each other. For example, the PCIe connector 342 and the PCIe connector 241 are connected to each other, directly or with a PCIe cable.

PCIe connectors 342 are provided individually for each computing apparatus 200 (computing apparatuses 200-1 to 200-4) to be connected. In addition, a PCIe connector 241 is provided in each computing apparatus 200 (computing apparatuses 200-1 to 200-4). Then, the PCIe connector 241 of a computing apparatus 200 and the PCIe connector 342 corresponding to the computing apparatus 200 are connected to each other.

When the PCIe connector 342 and the PCIe connector 241 are connected to each other, PCIe-based communication is performed using signal lines included in the region of the PCIe connector 342 corresponding to the EP port 323 and the region of the PCIe connector 241 corresponding to the RC port 211. In addition, signal lines included in the region of the PCIe connector 342 corresponding to an expansion port 332 and the region of the PCIe connector 241 corresponding to an expansion port 242 are used as the recovery signal line RCV and the reset signal line RST.

In this way, out of the signal lines in the PCIe connectors connecting each of the host apparatus 100 and computing apparatus 200 and the relay apparatus 300, extra signal lines are used as the recovery signal lines RCV and reset signal lines RST. This eliminates the need of providing additional signal lines for setting the computing apparatus 200 to recovery mode, between each of the host apparatus 100 and computing apparatus 200 and the relay apparatus 300. That is, it becomes possible to set the computing apparatus 200 to recovery mode under control from the host apparatus 100, at a low cost without modifying the basic configurations of the apparatuses.

In this connection, in the case of making an instruction to reboot the computing apparatus 200 to be recovered using a power supply control signal that is output from the expansion port 114 to the power supply control microcomputer 330, the reset signal lines RST do not need to be provided, as described earlier. In this case, a signal line of the expansion ports 113 and 331 may be used as the power supply control signal line PWR_h for sending the power supply control signal from the expansion port 114 of the host apparatus 100 to the power supply control microcomputer 330. In this case, a signal line of the expansion ports 332 and 242 may be used as the power supply control signal line PWR_c for sending the power supply control signal from the power supply control microcomputer 330 to the computing apparatus 200.

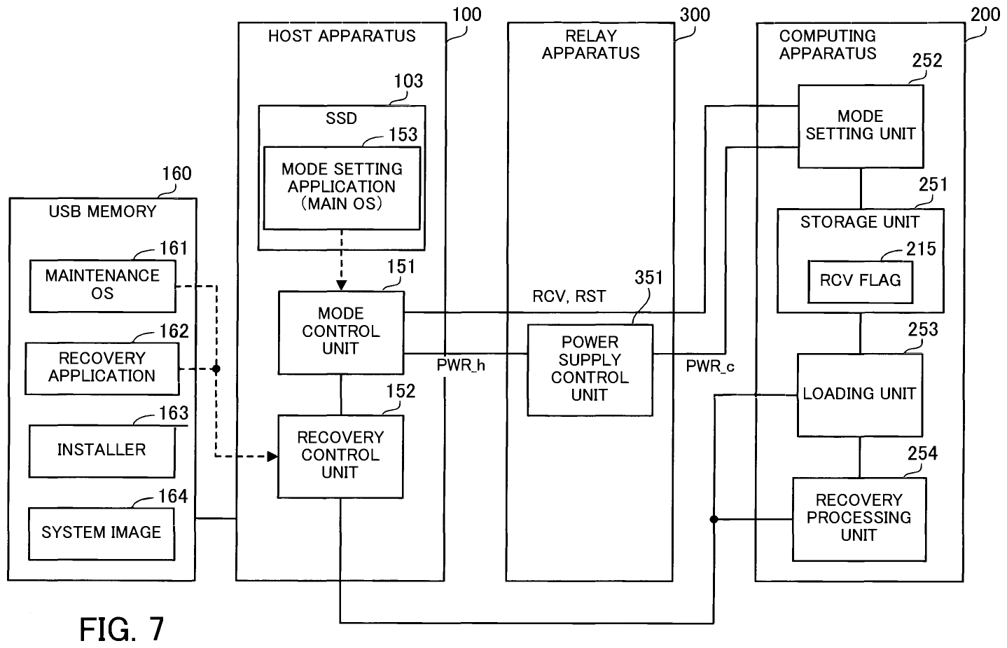

FIG. 7 illustrates an example of a configuration of processing functions in an information processing system.

The host apparatus 100 includes a mode control unit 151 and a recovery control unit 152. The SSD 103 of the host apparatus 100 stores therein a mode setting application 153 that runs on a main OS. A USB memory 160 is connected to the USB port 115 of the host apparatus 100. The USB memory 160 stores therein a maintenance OS 161, a recovery application 162, an installer 163, and a system image 164. The system image 164 includes an OS that runs on the computing apparatus 200 and a variety of applications that run on the OS, for example.

The processing of the mode control unit 151 is implemented by the processor 101 executing the mode setting application 153. When the recovery operation starts for the computing apparatus 200, the mode control unit 151 changes the recovery signal line RCV from low level to high level and then makes an instruction to reboot the computing apparatus 200. Thereby, the computing apparatus 200 to be recovered reboots in recovery mode. The instruction to reboot the computing apparatus 200 is made by changing the reset signal line RST from low level to high level or by sending a power supply control signal for the instruction to reboot the computing apparatus 200 from the expansion port 114 to a power supply control unit 351.

The processing of the recovery control unit 152 is implemented by the processor 101 executing the recovery application 162 under an environment in which the host apparatus 100 runs the maintenance OS 161. After the mode control unit 151 makes an instruction to reboot the computing apparatus 200 to be recovered as described above, the USB memory 160 is connected to the USB port 115 of the host apparatus 100, which reboots the host apparatus 100. At the reboot, the processor 101 of the host apparatus 100 reads the maintenance OS 161 from the USB memory 160 and executes it. When the maintenance OS 161 starts, the processor 101 additionally reads and executes the recovery application 162, which activates the recovery control unit 152.

In addition, at this time, the USB port 116 of the host apparatus 100 and the USB port 214 of the computing apparatus 200 to be recovered are connected to each other with a USB cable. The recovery control unit 152 reads the installer 163 from the USB memory 160 and transfers it to the computing apparatus 200 through the USB cable. The installer 163 is a program for installing the system image 164. The installer 163, when running on the computing apparatus 200, is able to install the system image 164.

After that, the recovery control unit 152 reads the system image 164 from the USB memory 160 and transfers it to the computing apparatus 200 through the USB cable. The system image 164 is data image for updating the entire system data stored in the non-volatile memory 203 of the computing apparatus 200. The system image 164 transferred is installed in the computing apparatus 200, so that the system data stored in the non-volatile memory 203 is rewritten with the system image 164. In this way, the recovery of the computing apparatus 200 is completed.

The relay apparatus 300 includes the power supply control unit 351. The processing of the power supply control unit 351 is implemented by the power supply control microcomputer 330. The power supply control unit 351 powers on and off a specified computing apparatus 200 through the power supply control signal line PWR_c in response to an instruction based on a power supply control signal received from the mode control unit 151 through the power supply control signal line PWR_h.

The computing apparatus 200 includes a storage unit 251, a mode setting unit 252, a loading unit 253, and a recovery processing unit 254.

The storage unit 251 is implemented by the storage space of the non-volatile memory 203, for example. The storage unit 251 stores therein the above-described RCV flag 215.

The processing of the mode setting unit 252 is implemented by an application stored in advance in the non-volatile memory 203. When the recovery signal line RCV is changed from low level to high level, the mode setting unit 252 changes the RCV flag 215 from “0” to “1.” In addition, when the signal level of the reset signal line RST is changed from low level to high level, the mode setting unit 252 reboots the computing apparatus 200 by powering it off and then on. Alternatively, the mode setting unit 252 may reboot the computing apparatus 200 on the basis of a power supply control signal output from the power supply control unit 351.

The processing of the loading unit 253 is implemented by a program (for example, basic input/output system (BIOS)) stored in advance in the non-volatile memory 203. When the RCV flag 215 stored in the storage unit 251 is “1” at the startup of the computing apparatus 200, the loading unit 253 starts up the computing apparatus 200 in recovery mode. Then, the loading unit 253 reads the installer 163 from the recovery control unit 152 through the USB cable connected to the host apparatus 100 and causes the processor 201 to execute the installer 163. The execution of the installer 163 activates the recovery processing unit 254.

The recovery processing unit 254 reads the system image 164 from the recovery control unit 152 through the USB cable connected to the host apparatus 100. The recovery processing unit 254 updates the system data in the storage unit 251 to the read system image 164, thereby recovering the computing apparatus 200.

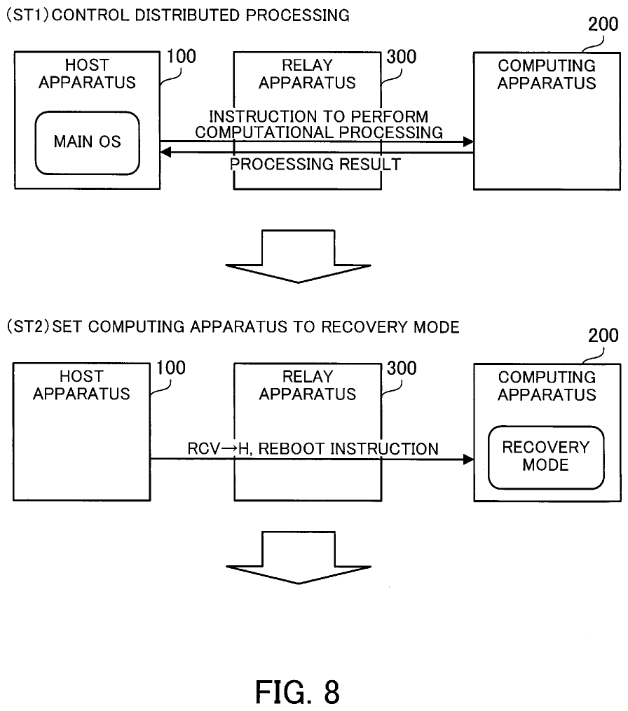

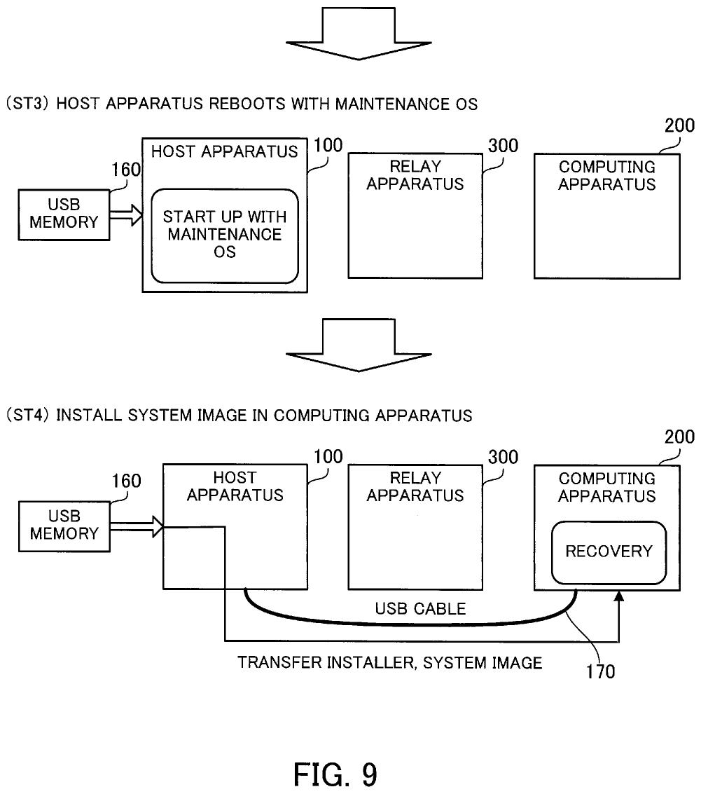

FIGS. 8 and 9 illustrate an outline of a recovery procedure for a computing apparatus.

(State ST1) The host apparatus 100 runs the main OS, and a specific application running on the main OS controls distributed processing for AI inference and image processing performed by the computing apparatuses 200. For example, the host apparatus 100 instructs the computing apparatuses 200 to perform computational processing and receives the processing results from the computing apparatuses 200. In addition, the host apparatus 100 is able to supply a processing result obtained by one computing apparatus 200 to another computing apparatus 200, cause the other computing apparatus 200 to execute another computational processing, and receive the processing result from the other computing apparatus 200. Communication for such control of the distributed processing is performed via the bridge controller 310 of the relay apparatus 300.

(State ST2) When starting to recover a computing apparatus 200, the host apparatus 100 executes the mode setting application 153 that runs on the main OS. The mode setting application 153 sets the recovery signal line RCV from low level to high level. This updates the RCV flag 215 of the computing apparatus 200 from “0” to “1.” In addition, the mode setting application 153 sets the reset signal line RST from low level to high level, to thereby make an instruction to reboot the computing apparatus 200. In response to this instruction, the computing apparatus 200 is powered off and then on. Since the RCV flag 215 is “1,” the computing apparatus 200 starts up in recovery mode.

In this connection, the instruction to reboot the computing apparatus 200 is made using a power supply control signal that is sent from the expansion port 114 of the host apparatus 100 to the power supply control microcomputer 330. In this case, it is possible to reboot only a computing apparatus to be recovered among the computing apparatuses 200-1 to 200-4.

(State ST3) Then, the USB memory 160 is connected to the USB port 115 of the host apparatus 100, which reboots the host apparatus 100. At this time, the host apparatus 100 starts up with the maintenance OS 161 stored in the USB memory 160. That is, the host apparatus 100 switches the running OS from the main OS to the maintenance OS 161. In addition, the host apparatus 100 executes the recovery application 162 stored in the USB memory 160.

(State ST4) Then, the USB port 116 of the host apparatus 100 and the USB port 214 of the computing apparatus 200 are connected with a USB cable 170. The host apparatus 100 running the maintenance OS 161 for recovering the computing apparatus 200 is USB-connected to the computing apparatus 200 being in recovery mode, and by doing so, it becomes possible to recover the computing apparatus 200 under control from the host apparatus 100.

Under this state, the installer 163 stored in the USB memory 160 is transferred from the host apparatus 100 to the computing apparatus 200 through the USB cable 170, and the installer 163 is executed by the computing apparatus 200. In addition, the system image 164 stored in the USB memory 160 is transferred from the host apparatus 100 to the computing apparatus 200 through the USB cable 170, so that the system data stored in the computing apparatus 200 is rewritten with the system image 164.

After that, the host apparatus 100 sets the recovery signal line RCV to low level and makes an instruction to reboot the computing apparatus 200, although not illustrated. The computing apparatus 200 starts up in normal mode because of the RCV flag 215 of “0.” Alternatively, the computing apparatus 200 may automatically reboot in normal mode a prescribed period of time after starting up in recovery mode. The computing apparatus 200 is able to start up in normal mode properly using the rewritten system image 164.

With the above procedure, the RCV flag 215 is set to “1” using the added recovery signal line RCV, and then an instruction to reboot the computing apparatus 200 is made using the added reset signal line RST or the power supply control signal that is sent to the power supply control microcomputer 330. By doing so, the computing apparatus 200 is switched to recovery mode in response to the instruction from the host apparatus 100. That is to say, the host apparatus 100 is able to alternatively take control of the above-described procedure 1 provided for the computing apparatus 200.

In addition, the use of the USB memory 160 enables the host apparatus 100 to execute the maintenance OS 161, and the connection of the host apparatus 100 to the USB port 214 of the computing apparatus 200 enables the host apparatus 100 to rewrite the system data of the computing apparatus 200. That is to say, the host apparatus 100 is able to alternatively take control of the above-described procedure 2 provided for the computing apparatus 200.

In this way, the recovery is performed in accordance with the definitions of the recovery procedure provided for the computing apparatus 200 under control from the host apparatus 100. This enhances the efficiency of the operation of recovering the computing apparatus 200. For example, there is no need of removing the housing of the information processing system 50 and operating a switch in order to set the computing apparatus 200 to recovery mode, which enhances the efficiency of the operation of setting the computing apparatus 200 to recovery mode. In addition, instead of connecting a dedicated maintenance computer to the computing apparatus 200 and operating the maintenance computer, the OS running on the host apparatus 100 is switched to the maintenance OS 161. By doing so, it becomes possible to install a system image in the computing apparatus 200 using the host apparatus 100. This enhances the efficiency of the installation operation.

In addition, according to the above-described procedure, while running the main OS, the host apparatus 100 performs processing up to when the computing apparatus 200 starts up in recovery mode. Therefore, an administrator is able to start the recovery operation naturally from a state where he/she operates the host apparatus 100 normally.

In addition, there is no need of operating a switch provided in the module of the computing apparatus 200 in order to set the computing apparatus 200 to recovery mode. This eliminates the need of forming an opening dedicated for operating the switch in the housing of the information processing system 50. This results in reducing the cost to develop the information processing system 50 and to increase flexibility in the design of the housing.

In this connection, a signal line (corresponding to the USB cable 170) for transferring the installer 163 and system image 164 may be provided in the information processing system 50 in advance. For example, a signal line may be provided in advance to connect the physical port (GPIO) of the expansion interface 108 of the host apparatus 100 and the USB port 214 of each computing apparatus 200 via the relay apparatus 300.

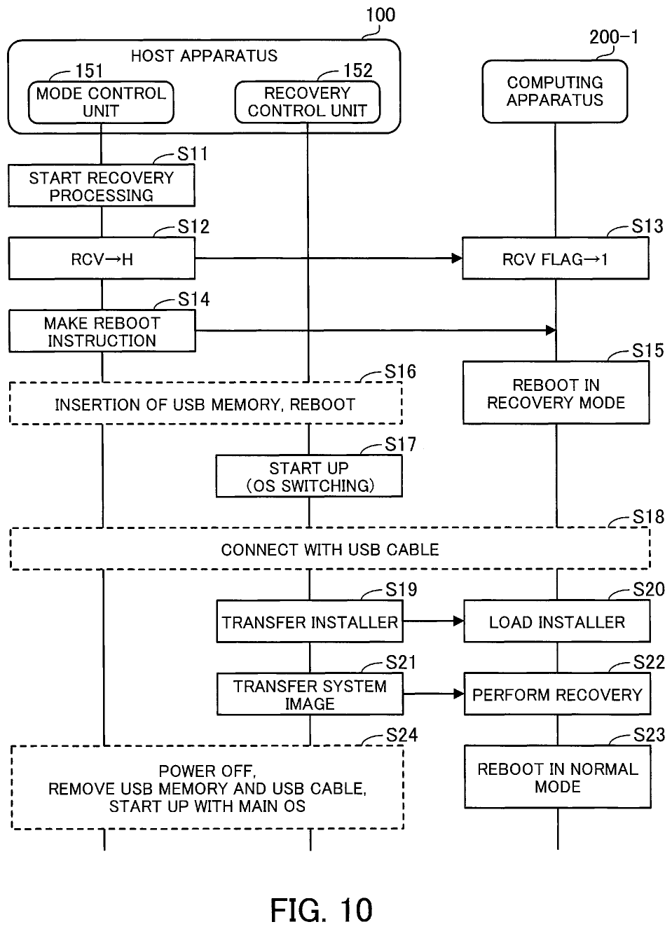

FIG. 10 is a sequence diagram illustrating an example of a recovery procedure for a computing apparatus. FIG. 10 describes an example where the computing apparatus 200-1 is recovered.

(Step S11) An administrator operates the host apparatus 100 to execute the mode setting application 153 while the host apparatus 100 runs the main OS. Thereby, the host apparatus 100 activates the mode control unit 151.

(Step S12) The mode control unit 151 sets the recovery signal line RCV from low level to high level.

(Step S13) When detecting that the recovery signal line RCV has become high level, the mode setting unit 252 of the computing apparatus 200-1 updates the RCV flag 215 from “0” to “1.”

(Step S14) The mode control unit 151 makes an instruction to reboot the computing apparatus 200-1. For example, the mode control unit 151 sets the reset signal line RST from low level to high level. Alternatively, the mode control unit 151 may send a power supply control signal for making an instruction to reboot the computing apparatus 200-1 to the power supply control unit 351 of the relay apparatus 300 through the power supply control signal line PWR-h. In the latter case, the power supply control unit 351 sends the power supply control signal making the reboot instruction through the power supply control signal line PWR-c connected to the computing apparatus 200-1.

(Step S15) The computing apparatus 200-1 reboots by powering off and then on. At the reboot, the loading unit 253 of the computing apparatus 200-1 starts up the computing apparatus 200-1 in recovery mode since the RCV flag 215 is “1.”

(Step S16) The administrator connects the USB memory 160 to the USB port 115 of the host apparatus 100 to thereby make an instruction to reboot the host apparatus 100.

(Step S17) The host apparatus 100 reboots with the maintenance OS 161 read from the USB memory 160. For example, by the administrator pressing a prescribed key on the input device 105 when the host apparatus 100 starts up, a selection screen for selecting a boot method is displayed on the display 104. Then, by the administrator selecting a USB boot, the boot process by the maintenance OS 161 stored in the USB memory 160 is initiated. Thereby, the OS switching is done.

In addition, the recovery application 162 in the USB memory 160 is executed, according to administrator's operation or automatically. Thereby, the recovery control unit 152 is activated in the host apparatus 100.

(Step S18) The administrator connects the USB port 116 of the host apparatus 100 and the USB port 214 of the computing apparatus 200 with the USB cable 170.

(Step S19) The recovery control unit 152 reads the installer 163 from the USB memory 160 and transfers it to the computing apparatus 200-1 through the USB cable 170.

(Step S20) The loading unit 253 of the computing apparatus 200-1 loads the installer 163 transferred and executes the installer 163. Thereby, the recovery processing unit 254 is activated in the computing apparatus 200-1.

(Step S21) The recovery control unit 152 reads the system image 164 from the USB memory 160 and transfers it to the computing apparatus 200-1 through the USB cable 170.

(Step S22) The recovery processing unit 254 of the computing apparatus 200-1 receives the system image 164 transferred and rewrites the system data stored in the non-volatile memory 203 with the system image 164. Thereby, the recovery of the computing apparatus 200-1 is done.

(Step S23) The computing apparatus 200-1 reboots. This reboot is performed in response to an instruction from the recovery control unit 152, for example. Alternatively, the computing apparatus 200-1 may automatically reboot a prescribed period of time after it starts up in recovery mode. The computing apparatus 200-1 starts up in normal mode properly with the system data rewritten with the system image 164.

(Step S24) The administrator powers off the host apparatus 100. Alternatively, the recovery control unit 152 may power off the host apparatus 100 when detecting the completion of rewriting with the system image 164. In addition, the USB memory 160 is removed from the host apparatus 100 and the USB cable 170 connecting the host apparatus 100 and the computing apparatus 200-1 is removed as well. Then, the host apparatus 100 is powered on. Thereby, the host apparatus 100 starts up with the main OS.

### Modification Example of Second Embodiment

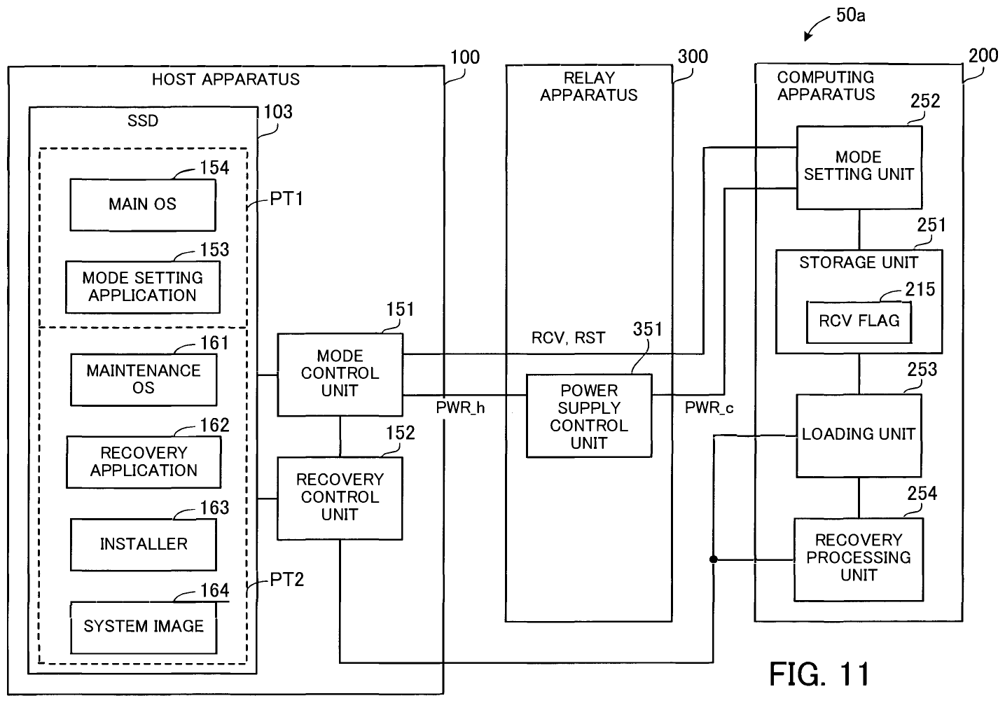

In the above second embodiment, the maintenance OS 161, recovery application 162, installer 163, and system image 164 are stored in the external USB memory 160. Alternatively, these data may be stored in the host apparatus 100 in advance. The following describes a case where the system of the second embodiment is modified in this way, with reference to FIG. 11.

FIG. 11 illustrates an example of a configuration of processing functions according to a modification example of the second embodiment. In FIG. 11, the same elements as those in FIG. 7 are denoted by the same reference numerals as used in FIG. 7.

In the information processing system 50a illustrated in FIG. 11, the storage space of an SSD 103 provided in a host apparatus 100 is divided into partitions PT1 and PT2. The partition PT1 stores therein a main OS 154 and a mode setting application 153 in advance. When the mode setting application 153 in the partition PT1 is executed, a mode control unit 151 is activated. Although not illustrated, the partition PT1 also stores therein a variety of applications that run on the main OS 154, including an application that controls distributed processing performed by computing apparatuses 200.

The partition PT2 stores therein a maintenance OS 161, a recovery application 162, an installer 163, and a system image 164 in advance. For example, the OS switching (corresponding to steps S16 and S17 of FIG. 10) is performed as follows. When an administrator reboots the host apparatus 100 and then presses a prescribed key on an input device at the startup of the host apparatus 100, an OS selection screen is displayed on a display 104. By the administrator selecting the maintenance OS 161, the boot process by the maintenance OS 161 in the partition PT2 is initiated.

After that, the recovery application 162 in the partition PT2 is executed, so that a recovery control unit 152 is activated. Then, the recovery control unit 152 transfers the installer 163 and system image 164 from the partition PT2 to a computing apparatus 200.

This modification example eliminates the workload of connecting the USB memory 160 to the host apparatus 100, which enhances the efficiency of the recovery operation more than the second embodiment. However, the second embodiment that uses the USB memory 160 has the following advantages: data used for recovery does not consume the storage space of the host apparatus 100; and it is possible to install a latest version of maintenance OS 161 and system image 164 in the computing apparatus 200.

### Third Embodiment

In the above-described second embodiment, the host apparatus 100 executes an application on a main OS in order to perform a process of switching the computing apparatus 200 to be recovered to recovery mode. Alternatively, the host apparatus 100 may use an application that runs on a maintenance OS 161 to perform this process. The following describes a third embodiment in which the second embodiment is modified in this way.

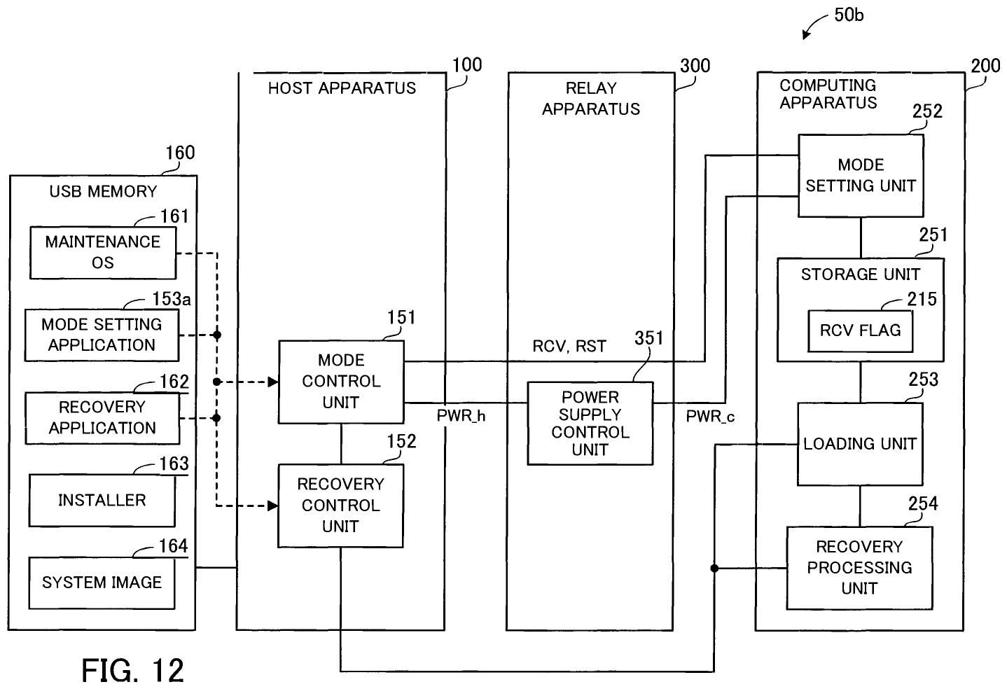

FIG. 12 illustrates an example of a configuration of processing functions in an information processing system according to a third embodiment. In FIG. 12, the same elements as those in FIG. 7 are denoted by the same reference numerals as used in FIG. 7.

The information processing system 50b illustrated in FIG. 12 uses a mode setting application 153a that runs on a maintenance OS 161, in place of the mode setting application 153 that runs on a main OS. The mode setting application 153a is stored in a USB memory 160 together with the maintenance OS 161. The processing of a mode control unit 151 of the host apparatus 100 is implemented by the mode setting application 153a.

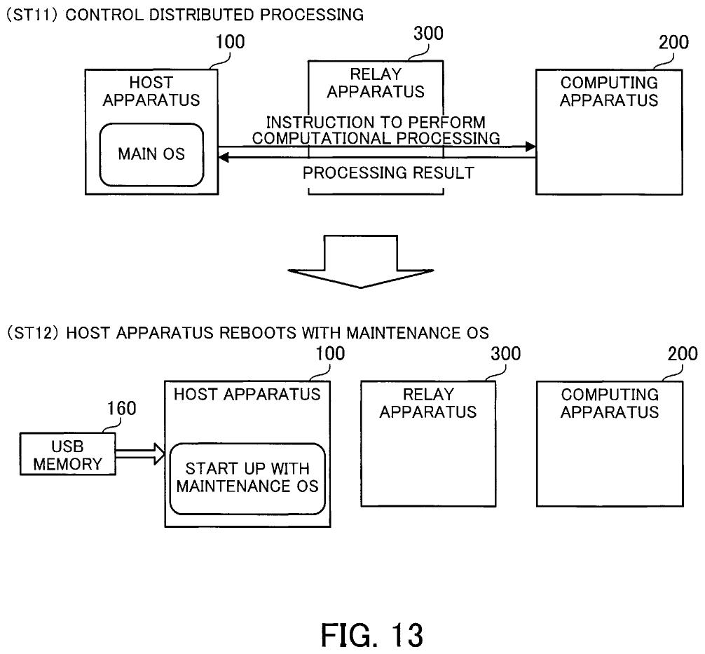

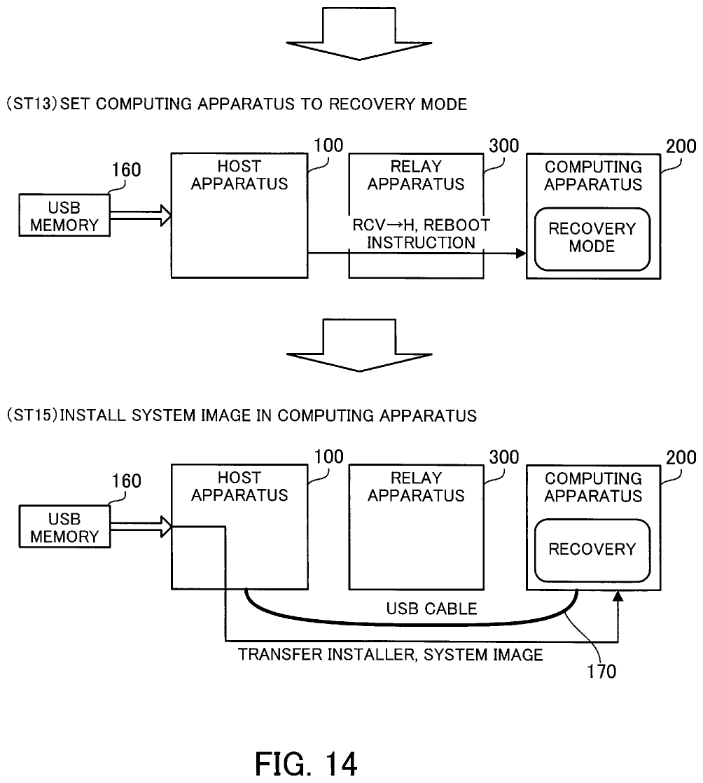

FIGS. 13 and 14 illustrate an outline of a recovery procedure for a computing apparatus according to the third embodiment.

(State ST11) As in the state ST1 of FIG. 8, the host apparatus 100 executes a prescribed application on a main OS to control distributed processing for AI inference and image processing performed by computing apparatuses 200.

(State ST12) When the recovery of a computing apparatus 200 starts, the USB memory 160 is connected to a USB port 115 of the host apparatus 100, which reboots the host apparatus 100. At this time, the host apparatus 100 starts up with the maintenance OS 161 stored in the USB memory 160. That is, the OS of the host apparatus 100 is switched from the main OS to the maintenance OS 161.

(State ST13) Then, the host apparatus 100 executes the mode setting application 153a stored in the USB memory 160. Then, the mode setting application 153a sets a recovery signal line RCV from low level to high level. Thereby, an RCV flag 215 of the computing apparatus 200 is updated from “0” to “1.” Further, the mode setting application 153a sets a reset signal line RST from low level to high level to thereby make an instruction to reboot the computing apparatus 200. The computing apparatus 200 is powered off and then on in accordance with the instruction. The computing apparatus 200 starts up in recovery mode because the RCV flag 215 is “1.”

In this connection, the instruction to reboot the computing apparatus 200 may be made using a power supply control signal that is sent from an expansion port 114 of the host apparatus 100 to a power supply control microcomputer 330. In this case, it is possible to reboot only a computing apparatus to be recovered among computing apparatuses 200-1 to 200-4.

(State ST15) Then, a USB port 116 of the host apparatus 100 and a USB port 214 of the computing apparatus 200 are connected with a USB cable 170. In addition, the host apparatus 100 executes the recovery application 162 stored in the USB memory 160. Then, the recovery application 162 transfers the installer 163 stored in the USB memory 160 from the host apparatus 100 to the computing apparatus 200 through the USB cable 170, so that the computing apparatus 200 executes the installer 163. In addition, the recovery application 162 transfers the system image 164 stored in the USB memory 160 from the host apparatus 100 to the computing apparatus 200 through the USB cable 170, so that the system data in the computing apparatus 200 is rewritten with the system image 164.

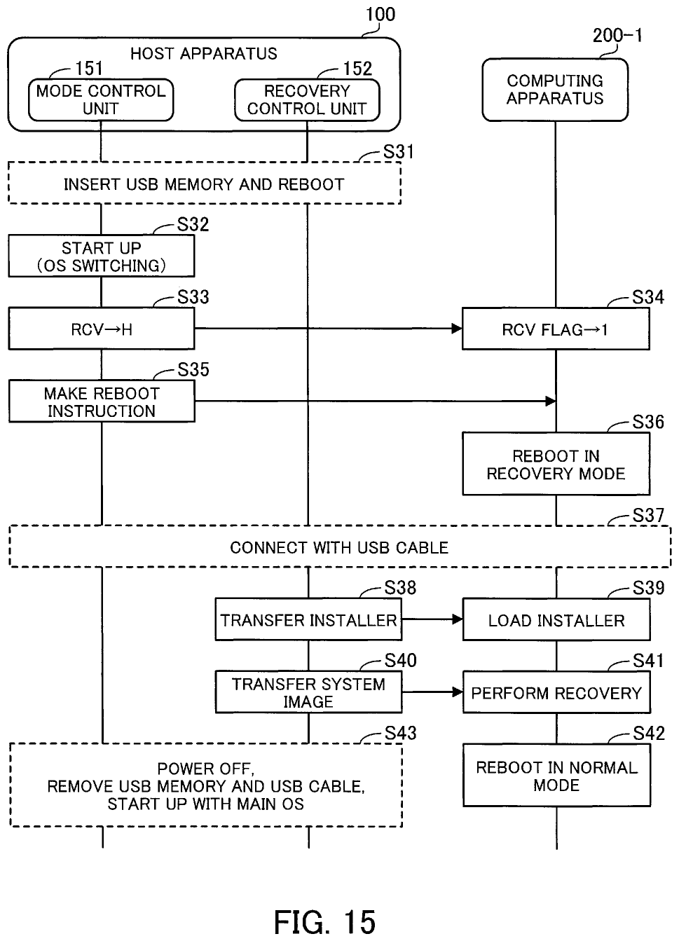

FIG. 15 is a sequence diagram illustrating an example of a recovery procedure for a computing apparatus according to the third embodiment. FIG. 15 illustrates an example where the computing apparatus 200-1 is recovered.

(Step S31) While the host apparatus 100 runs the main OS, an administrator connects the USB memory 160 to the USB port 115 of the host apparatus 100 to thereby make an instruction to reboot the host apparatus 100.

(Step S32) The host apparatus 100 reboots with the maintenance OS 161 read from the USB memory 160 in the same way as step S17 of FIG. 10. In addition, the mode setting application 153a stored in the USB memory 160 is executed, according to administrator's operation or automatically. Thereby, the mode control unit 151 is activated in the host apparatus 100.

(Step S33) The mode control unit 151 sets the recovery signal line RCV from low level to high level.

(Step S34) When detecting that the recovery signal RCV has become high level, the mode setting unit 252 of the computing apparatus 200-1 updates the RCV flag 215 from “0” to “1.”

(Step S35) The mode control unit 151 makes an instruction to reboot the computing apparatus 200-1 in the same way as step S14 of FIG. 10.

(Step S36) The computing apparatus 200-1 reboots by powering off and then on. At the reboot, a loading unit 253 of the computing apparatus 200-1 starts up the computing apparatus 200-1 in recovery mode because of the RCV flag 215 of “1.”

(Step S37) The administrator connects the USB port 116 of the host apparatus 100 and the USB port 214 of the computing apparatus 200 with the USB cable 170.

(Step S38) The recovery application 162 stored in the USB memory 160 is executed, according to administrator's operation or automatically. Thereby, the recovery control unit 152 is activated in the host apparatus 100. The recovery control unit 152 reads the installer 163 from the USB memory 160 and transfers it to the computing apparatus 200-1 through the USB cable 170.

(Step S39) The loading unit 253 of the computing apparatus 200-1 loads the installer 163 transferred and executes the installer 163. Thereby, the recovery processing unit 254 is activated in the computing apparatus 200-1.

(Step S40) The recovery control unit 152 reads the system image 164 from the USB memory 160 and transfers it to the computing apparatus 200-1 through the USB cable 170.

(Step S41) The recovery processing unit 254 of the computing apparatus 200-1 receives the system image 164 transferred and rewrites the system data stored in a non-volatile memory 203 with the received system image 164. Thereby, the recovery of the computing apparatus 200-1 is done.

(Step S42) The computing apparatus 200-1 reboots in the same way as step S23 of FIG. 10. At this time, the computing apparatus 200-1 starts up in normal mode properly with the system data rewritten with the system image 164.

(Step S43) The host apparatus 100 is powered off, the USB memory 160 and USB cable 170 are removed, and the host apparatus 100 is powered on, in the same way as step S24 of FIG. 10. Thereby, the host apparatus 100 starts up with the main OS.

According to the above-described third embodiment, while running the maintenance OS 161, the host apparatus 100 performs the series of processing for recovering the computing apparatus 200. Since the programs and data for executing the series of processing are stored in the USB memory 160, these programs and data do not consume the storage space of the host apparatus 100. Therefore, the third embodiment increases the use efficiency of the storage space in the host apparatus 100, compared with the second embodiment and the modification example thereof.

As in the modification example of FIG. 11, the maintenance OS 161, mode setting application 153a, recovery application 162, installer 163, and system image 164 used in the third embodiment may be stored in a storage device provided in the host apparatus 100 in advance. In this case, OS switching (corresponding to steps S31 and S32 of FIG. 15) is performed as follows, for example. When the administrator reboots the host apparatus 100 and then presses a prescribed key on the input device 105 at the startup of the host apparatus 100, an OS selection screen is displayed on the display 104. Then, by the administrator selecting the maintenance OS 161, the boot process by the maintenance OS 161 is initiated in the host apparatus 100.

The processing functions of each apparatus (for example, the information processing apparatus 10, computing apparatuses 20-1 to 20-3, host apparatus 100, and computing apparatuses 200-1 to 200-4) described in the above-described embodiments may be implemented by using a computer. In this case, a program describing the processing content of the functions implemented by an individual apparatus is provided, and the processing functions are implemented on a computer by causing the computer to execute the program. The program describing the processing content may be recorded on a computer-readable storage medium. Computer-readable storage media include magnetic storage devices, optical discs, magneto-optical storage media, semiconductor memories, and others. Magnetic storage devices include hard disk drives (HDDs), magnetic tapes, and others. Optical discs include compact discs (CDs), digital versatile discs (DVDs), Blu-ray discs (BDs, registered trademark), and others. Magneto-optical storage media include magneto-optical (MO) disks and others.

To distribute the program, portable storage media, such as DVDs and CDs, on which the program is recorded, may be put on sale, for example. Alternatively, the program may be stored in a memory device of a server computer and may be transferred from the server computer to other computers.

A computer that executes the program may store the program recorded on a portable storage medium or the program received from the server computer in a local storage device. Then, the computer reads the program from the local storage device, and performs processing according to the program. In this connection, the computer may read the program directly from the portable storage medium, and then perform processing according to the program. Alternatively, the computer may perform processing according to the program while receiving the program from the server computer over a network.

According to one aspect, a computing apparatus is able to be recovered under control from an information processing apparatus.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. An information processing system, comprising:
a relay apparatus including a relay unit configured to relay communication over an expansion bus;
a plurality of computing apparatuses each connected to the expansion bus; and
an information processing apparatus configured to control computational processing performed by the plurality of computing apparatuses via the expansion bus and the relay unit while running a first operating system, to switch a running operating system to a second operating system, and to rewrite system data of one computing apparatus among the plurality of computing apparatuses in order to recover the one computing apparatus.

2. The information processing system according to claim 1, further comprising:
a signal line connecting each of the plurality of computing apparatuses and the information processing apparatus, the signal line passing through the relay apparatus,
wherein the information processing apparatus outputs, through the signal line, a control signal for switching the one computing apparatus to recovery mode, makes an instruction to reboot the one computing apparatus so as to cause the one computing apparatus to start up in the recovery mode, and recovers the one computing apparatus that has rebooted in the recovery mode.

3. The information processing system according to claim 2, wherein the information processing apparatus
outputs the control signal to the one computing apparatus and makes the instruction to reboot the one computing apparatus while running the first operating system, and
switches the running operating system to the second operating system after making the instruction to reboot the one computing apparatus, and then recovers the one computing apparatus that has rebooted in the recovery mode.

4. The information processing system according to claim 2, wherein, while running the second operating system after switching the running operating system to the second operating system, the information processing apparatus outputs the control signal to the one computing apparatus, makes the instruction to reboot the one computing apparatus, and recovers the one computing apparatus that has rebooted in the recovery mode.

5. The information processing system according to claim 2, wherein:
the information processing apparatus includes a first connector that is connected to the relay apparatus with the expansion bus;
the plurality of computing apparatuses each include a second connector that is connected to the relay apparatus with the expansion bus;
the relay apparatus includes a third connector that is connected to the information processing apparatus with the expansion bus and a fourth connector that is connected to each of the plurality of computing apparatuses with the expansion bus; and
the signal line is an extra internal signal line that is not used in communication via the relay unit, among internal signal lines included in each of the first, second, third, and fourth connectors.

6. The information processing system according to claim 1, wherein, upon detecting that a portable storage medium storing the second operating system has been connected to the information processing apparatus, the information processing apparatus reads the second operating system from the portable storage medium and switches the running operating system to the second operating system.

7. The information processing system according to claim 1, wherein the plurality of computing apparatuses and the information processing apparatus individually act as root complexes in the expansion bus, and the relay unit acts as end points respectively corresponding to the root complexes in the expansion bus and relays communication between the end points.

8. An information processing method, comprising:
controlling, by an information processing apparatus connected to an expansion bus, computational processing performed by a plurality of computing apparatuses via the expansion bus and a relay unit while the information processing apparatus runs a first operating system, the relay unit being included in a relay apparatus and being configured to relay communication over the expansion bus, the plurality of computing apparatuses each being connected to the expansion bus; and
switching, by the information processing apparatus, a running operating system of the information processing apparatus to a second operating system, and rewriting system data of one computing apparatus among the plurality of computing apparatuses in order to recover the one computing apparatus.
